(19) United States
(12) Patent Application Publication
(10) Pub. No.: US 2022/0254331 A1
(43) Pub. Date: Aug. 11, 2022

(54) NEURAL NETWORK AND METHOD FOR MACHINE LEARNING ASSISTED SPEECH RECOGNITION

(71) Applicant: CAMBIUM ASSESSMENT, INC., Washington, DC (US)

(72) Inventor: Amir Hossein Jafari, Fairfax, VA (US)

(73) Assignee: CAMBIUM ASSESSMENT, INC., WASHINGTON, DC (US)

(21) Appl. No.: 17/168,987

(22) Filed: Feb. 5, 2021

(51) Int. Cl. G10L 15/01; G10L 15/16; G06N 20/20; G06F 17/18; G06F 9/54

(52) U.S. Cl. CPC G10L 15/01; G10L 15/16; G06F 9/547; G06F 17/18; G06N 20/20

(57) ABSTRACT

A system for machine learning assisted speech scoring can include a neural network, a memory for storing executable software code, and a processor. The executable software code can include a software framework, a preprocessing submodule, a transcriber class, a confidence submodule, and an application programming interface. The processor can implement commands, including instantiating transcribers from the transcriber class, invoking the preprocessing submodule, and ensembling the transcribers. The preprocessing submodule can be configured to downsample a raw audio file into an audio file. Each node of the neural network can have one or more of the transcribers. The transcribers can be configured to create text from the audio file.

### TECHNICAL FIELD

The present invention relates to systems and methods of machine learning for natural language processing.

### BACKGROUND

Artificial neural networks typically include large numbers of interconnected processing elements called neurons. Neural networks can employ machine learning. For example, a neural network can learn through experience to recognize patterns, classify data, devise complex models, and create new algorithms. This experiential learning can be based on sample data, commonly called training data, used to make and check predictions.

Problems faced in natural language processing are amongst the most difficult in the machine learning community. Previous approaches typically focused on a single neural network model for training in a silo type of architecture. Work on neural network ensembles typically dealt with each neural network separately.

### SUMMARY

The present invention is generally directed to systems and methods for machine learning and/or natural language processing. A system executing the methods can be directed by a program stored on non-transitory computer-readable media.

An aspect can include a system for machine learning assisted speech scoring. The system can have a neural network, a memory for storing executable software code, and a processor. The executable software code can include a software framework, a preprocessing submodule, a transcriber class, a confidence submodule, and an application programming interface. The processor can implement commands, including instantiating transcribers from the transcriber class, invoking the preprocessing submodule, and ensembling the transcribers. The preprocessing submodule can be configured to downsample a raw audio file into an audio file. Each node of the neural network can have one or more of the transcribers. The transcribers can be configured to create text from the audio file.

In an embodiment, the transcriber class can be encapsulated by the application programming interface.

In another embodiment, the neural network can be configured to score the text. The confidence submodule can be configured to calculate probabilities that the text was transcribed accurately. The system can be further configured to transcribe speech and/or predict scores in parallel, as well as to combine a plurality of scores to predict a final score.

Another aspect can include a method of scoring speech. The method can include preprocessing, transcribing, and scoring. Preprocessing can be performed on an audio file to, for example, filter out unscoreable audio and/or to downsample scorable audio. Transcribing can be performed on the audio file among a plurality of automated transcribers to create a plurality of transcripts. Scoring the plurality of transcripts can be performed among nodes of a neural network to create a plurality of scores. The transcribing and the scoring can be performed in parallel.

In an embodiment, the method can further include ensembling the plurality of transcripts and/or the plurality of scores. The method can include predicting a final score.

In another embodiment, the unscorable audio can be an audio file that contains no speech, that is longer than a predetermined time, that is corrupted, or that contains speech from multiple speakers.

In yet another embodiment, preprocessing can further include creating a condition code model.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates an architecture for a scoring engine.

FIG. 2 illustrates a flow for data segmentation and system training.

FIG. 3 illustrates preprocessing for cleaning and normalizing an audio file.

FIG. 4 shows distributions of classifications.

FIG. 5 shows a flow of data through a scoring engine.

FIG. 6 depicts a mel scale spectrogram for an audio file.

FIG. 7 illustrates an overview of an acoustic model.

FIG. 8 illustrates CTC-loss function used to compare two sequences.

FIG. 9 illustrates a beam search.

FIG. 10 shows a finetuning process.

FIG. 11 shows ensembling using a logistic regression.

FIG. 12 sets for specific results from a procedural example based on scores from Washington and Oregon ELPA 21 data.

### DETAILED DESCRIPTION

A detailed explanation of the system, method, and exemplary embodiments of the present invention are described below. Exemplary embodiments described, shown, and/or disclosed herein are not intended to limit the claims, but rather, are intended to instruct one of ordinary skill in the art as to various aspects of the invention. Other embodiments can be practiced and/or implemented without departing from the scope and spirit of the claimed invention.

A preferred embodiment can include an automated speech scoring engine. The engine can be designed to predict scores from audio files, such as those produced by examinees in response to English Language Assessment speaking items in K-12 programs. The engine can be trained and/or validated on scores, such as those assigned by human raters who listen to each student response and/or assign a score using a scoring rubric, after having been trained and qualified to score. Some rubrics can be holistic (i.e., one trait), and can range, for example, from three scores (0,1,2) to six scores (0,1,2,3,4,5). Rubrics also can outline non-attempt responses that are off-topic or for which the response has no audible sound; such responses can be assigned descriptive codes, called condition codes, rather than rubric-based scores. Examinee ages typically range in K-12 from age 5 to 18. In some contexts, examinees are assessed because English is not their primary language spoken in their home, which usually can be identified via survey or prior test results. Such analyzed and/or scored examinee speech by the engine can reflect the diversity of languages spoken in the United States (or anywhere).

Student audio files can be processed by, for example, passing them through multiple transcribers. The results of transcriptions can be used as input into a series of neural networks that predict scores. High-level tasks used to implement a speech scoring engine can include preprocessing, transcription, neural network modelling, and ensembling.

In a preprocessing step, audio files can be processed to obtain statistics such as length, max frequency, etc. The statistics can be incorporated into a confidence model which can be used to measure quality of scoring and can be routed to human scoring if desired. Files can be further processed by normalizing amplitude frequencies and/or adjusting volume to obtain better quality audio files for transcription. Although various sampling frequencies are possible—as are various sampling methodologies—a sampling frequency of 16 KHz has been shown acceptable.

Processed audio files can be used as input to transcribers. Multiple transcribers can be created and implemented in parallel. The text transcriptions can be used as input to multiple language model neural network based models to predict scores. The predicted scores can be used as input, for example into a logistic regression classifier, to predict final score.

A gap in the field exists regarding using neural nets in automated speech scoring. But the use of such engines in both transcriptions and modelling, along with ensembles, can achieve a unique and advantageous architecture.

Automated speech scoring can be one the most challenging problems in the deep learning and artificial intelligence (AI) communities. Vast quantities of speech data are freely available that can be used for automated speech recognition tasks. For example, audio books, YouTube, 60 Minutes, and audio recordings of the Library of Congress (such as presidential speeches) have both audio and transcripts of the audio freely available. However, relatively little has been done in automated speech scoring or the classification of speech into ordinal scores based upon a scoring rubric. The architecture described below is unique in the automated speech scoring field in part due to it being an ensemble of automated transcribers and neural networks. Within this structure, multiple pieces can be combined to create an architecture which transcribes speech and predicts scores in parallel and can combine scores to predict a final score. Other unique elements are the preprocessing steps and confidence computation which can be used to route responses for human verification.

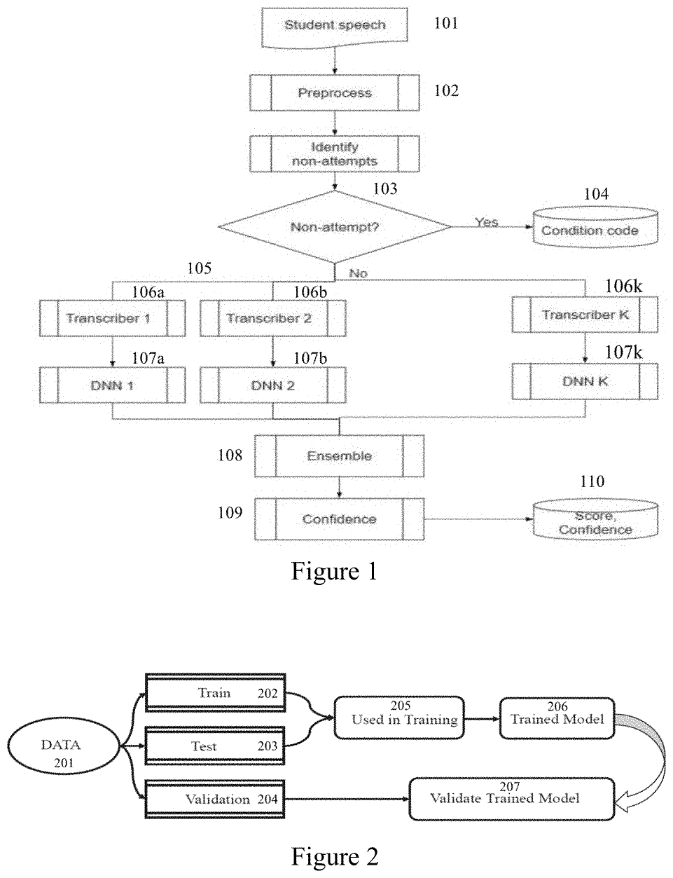

FIG. 1 shows the functional structure of an engine in a preferred embodiment. Various transcribers can be utilized, such as Nemo, Jasper, and wav2letter. And various neural network-based language models and ensemblers can be utilized, such as Bidirectional Encoder Representations from Transformers (BERT) and logistic regression, respectively.

A system can accept speech files, such as student speech (101), with any extensions (such as way, mp4, etc.). The system can then process, transcribe, and score the files. An overview of the process is shown in FIG. 1. The engine can employ steps that help identify potential scoring issues throughout the processing, transcription, and scoring pipeline, and it can address them by flagging responses as needing verification and/or ensembling multiple transcriber-neural network engines to leverage the different information from each source to predict a final score.

Given an input audio file, some level of cleaning and other preprocessing is typically required. Preprocessing (102) can involve using a sound processing utility, such as SoX 1, to normalize amplitude frequencies, adjust volumes, and downsample to 16 KHz. Preprocessing can include obtaining various numeric representations of the sound file, using SoX statistics. Thresholds can be applied to these statistics to flag responses (103) that are non-attempts or need human review and these responses are removed from processing. The audio files can be submitted to one or more transcription engines (106a, 106b, . . . 106k), each of which can convert the files to text and which can pass transcripts to deep neural networks (DNNs) (107a, 107b, . . . 107k). The DNNs can feed their output to an ensemble (108). The ensembled results can be analyzed (109) and a confidence score can be stored (110). An advantage of having multiple transcribers—each with their own model architecture—is that each can produce different transcriptions that as a set can represent the response correctly and thus produce better models for scoring. The transcriptions can be used in multiple models to classify them. A confidence model can be utilized to calculate confidence levels associated with the score. A model can be based on a probit regression or logistic regression to predict correctness of scores on a held-out validation sample and a separate, unscored sample to generate percentile values associated with the confidence values produced by the regression.

Series of tasks can be implemented at each step to score the speech data. Various aspects of such modules, tasks, subroutines, and/or steps (e.g. data preparation, preprocessing, flagging non-attempts, transcriber models, conversion to mel scale spectrogram, transcription, optimizing transcription using language models, fine tuning, deep neural networks) are discussed and described in greater detail herein.

Data preparation can be important and sometimes even necessary. FIG. 2 shows data segmentation. One can start with initial data (201), which can typically be divided into three datasets: training (202), testing (203), and validation set (204). The validation set can be retained to verify the result of training. Represented by 205, the training set can be used to train and/or finetune the transcription engines and/or the neural network-based language models (206). The train set can be used to train and finetune models and the test set is used during training to optimize the result of training. The validation set can be used to validate (207) the trained model and the test set can be used to optimize the models during training and estimate parameters for the ensembler. The data contain the sound file and the score (or scores) and condition codes assigned by the raters.

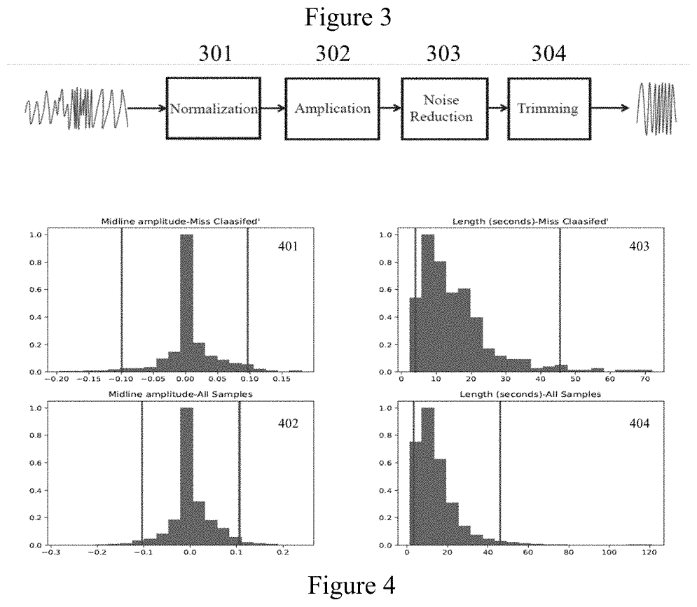

As noted above, preprocessing can be performed. FIG. 3 shows an exemplary preprocessing subprocess to clean and to normalize audio files. In some cases, amplification and some cases trimming can be performed to get clearer sounds with normalized amplitude. Embodiments can utilize various available tools, such as SoX, which is a cross-platform (Windows, Linux, MacOS X, etc.) command line utility that can convert various formats of computer audio files in to other formats, as well as provide additional audio-related functionality. See sox. sourceforge.net.

In some embodiments, SoX (or another utility) can be used within a subprocess (equivalent to running in a shell) to initially convert and downsample the audio to a uniform format. The converted file can also undergoe a cleaning process. An example of a cleaning process is described more fully below.

With respect to FIG. 3, normalization (301) can be performed on an audio sample. The can include automatically invoking a gain effect to guard against clipping and normalizing the audio (with respect to the maximum amplitude). Amplification (302) can be performed on the normalized sample. Any standard amplification (of the many known in the field) can be utilized. Noise reduction (303) can be performed. For example, A noise profile can be created and used to remove unwanted noise. Trimming (304) can be performed. For example, any silent sections of the audio file can be removed and responses can be concatenated. Silence can be detected and removed anywhere from the audio.

A cleaning process can be independently accessed via submodule. For example, if utilizing SoX, such assessment can be performed with the below lines.

from speech. tools. cleaning import clean
clean (audio_path, new_path)
Because the process should not change the original files themselves, the function requires a new path to store the cleaned file.

The engine can accept any audio file format as an input prior to preprocessing. It can be very important to identify corrupted files in the preprocessing step to use them to further flag non-attempts or condition codes. As an example of a corrupted file, when utilizing SoX, any file for which statistics cannot be calculated are considered corrupted.

With regard to flagging non-attempts, as noted above, statistics outputted, such as by the SoX statistics utility, can be used as features to detect non-attempt responses and/or responses that are unusual enough that they should be routed for hand scoring. Responses with unusual audio characteristics are likely to be ill-transcribed and so can be flagged for review. Various statistics that can be computed appear below.

Length (seconds): length of the audio file in seconds;

Scaled by: what the input is scaled by. By default 2³¹-1, to go from 32-bit signed integer to [−1, 1];

Maximum amplitude: maximum sample value;

Minimum amplitude: minimum sample value;

Midline amplitude: midpoint between the max and minimum values;

Mean norm: arithmetic mean of samples' absolute values;

Mean amplitude: arithmetic mean of samples' values;

RMS amplitude: root mean square, root of squared values' mean;

Maximum delta: maximum difference between two successive samples;

Minimum delta: minimum difference between two successive samples;

Mean delta: arithmetic mean of differences between successive samples;

RMS delta: root mean square of differences between successive samples;

Rough frequency: estimation of the input file's frequency, in hertz;

Volume adjustment: value that should be sent to −v so peak absolute amplitude is 1;

Statistics can also be obtained directly via commands, such as:

from speech . speech_machines . sox_statistics import get_statistics;
print( get_statistics ( example_file ));

FIG. 4 shows amplitude and histogram distributions of audio samples. The midline amplitude of misclassified samples (401) can be compared to the midline amplitude of all samples (402). The length of misclassified audio samples (403) can be compared to the length of all samples (404). Thresholds can be calculated based on, for example, 95 percent of samples falling into the distribution and the rest require hand scoring. The nature of the test (two-sided, single-sided) and thresholding can be varied according to program needs and/or preferences. The bottom histograms are the all sample data. The top figure are the same statistics but the misclassified samples between the engine predicted scores and the human scores. A threshold can be used to create a condition code for samples outside of the interval. In this example, a 95 percent confidence interval was used to find a threshold, but other percentages can of course be chosen based on preferences and/or specific goals.

Examples of kinds of responses to be flagged are listed below. Such files can be routed for review and/or flagged and assigned a condition code.

Blank audio files: It is not useful to score blank files.
Very long audio files: As noted earlier, thresholds can be defined using the data distribution or business needs.
Corrupted files: Corrupted speech files are flagged as such.
Multiple speaker: The presence of multiple speakers which may indicate cheating or other issues for flagging. Subroutines built with Java code has been utilized to detect multiple speakers, but existing open source code is available for detecting multiple speakers.

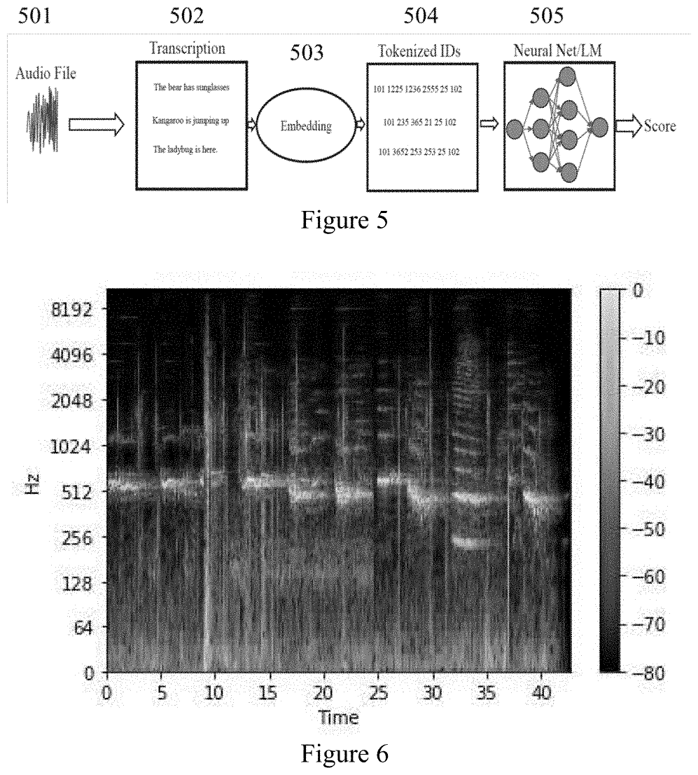

Transcriber models and transcribers can play a significant role in scoring. There are a lot of challenges in an automated speech recognition system that transcribes children's speaking in response to test items, particularly children for whom English is a second language or not the language spoken in their home. These challenges include lack of training data for certain age groups, accents, noise level, volume of speech, speech cadence, content of the speech, etc. We are going to inherit these challenges in the scoring system. Additionally, the type of words elicited in test items may be unusual in many corpora, and more frequently occurring words in the corpora (but incorrect) may be chosen by the transcription model. This is examined in more with respect to FIG. 5.

At a high level, the overall system can use audio files as input and perform two major steps. The first step is transcription and the second is classification of texts through neural network language model structures. The audio signals are converted to text. The text, in the form of strings is converted to an embedding vector. Three different embedding vectors can be added together, and the final vector can convert to an ID. The IDs can be input into the neural network language model to produce scores.

In FIG. 5, speech data (501) are provided as input to the automated scoring engine and the output is the scored speech. For each transcription (502), tokenization (504) can be performed to map each word to an embedding identifier associated with a neural network (505). An embedding identifier (503) of each word as input into a neural network (505) can be utilized to classify the speech files. Note here that the quality of the transcription clearly directly impacts the input into the neural network model, thereby impacting the quality of score prediction.

Conversion to mel scale spectrograms can be performed. For example, after the preprocessing step, the cleaned and processed audio files can be fed to transcribers such as Jasper and Wav2letter. All speech data can be converted to a mel scale spectrogram as in FIG. 6. In the figure, the x axis is time and y axes are frequency and the intensity. The depth of shading shows the third dimension. Every English alphanumeric character has patterns in time and frequency. Based on the intensity of mel spectrogram in time and frequency every vowel or sound has its own pattern. The mel scale data can be useful for identifying the characters. The mel scale spectrogram can be used as input into one or more of the neural networks.

For transcription, the encoder part of the network can use both the past and future elements of the mel scale spectrogram sequence. This can give a representation in a finite dimensional space of what token has been uttered. The decoder can interpret the log-probabilities of each token in a vocabulary. What constitutes a token can be different among various models. Hence, in a preferred embodiment, the transcribers can work in three different ways:

Character-level: The tokens are individual characters.
Word-level: The tokens are from a large finite set of known words.
Subword-level: The tokens are formed from a small set of sub-words.

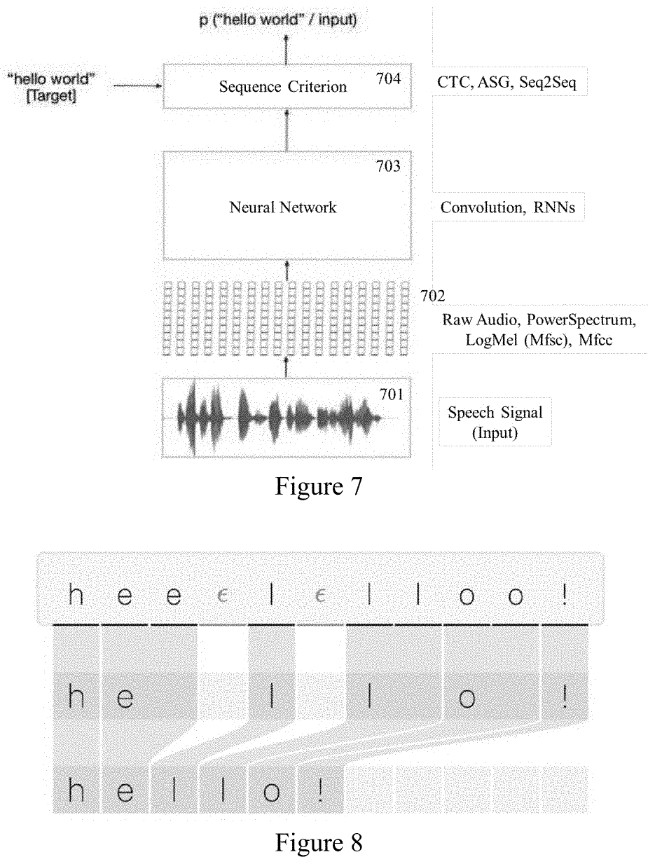

FIG. 7 shows an example of the model structure of transcribers. More particularly, the figure shows an ESPnet model architecture. A speech signal (701) can be used as input and a nel scale spectrum frequency is calculated as features. These features are time and frequency represented as a matrix (702). The audio signal can be converted to a mel spectrogram feature tensor. These tensors can be used as input to the convolution network, which are well equipped for pattern classification. Features can be fed into a multilayer neural network (703). Connectionist temporal classification (CTC) loss can be utilized to predict characters, word-pieces, or words (FIG. 8). Because the order of frequency can be important, a recurrent neural network (RNN) architecture can be used to capture the correlation of previous and next characters. The output of the RNN can be used by a sequence criterion engine (704). CTC loss can be considered a cost function for minimizing the error of prediction each charter.

The transcribers can be built, as persons in the field would readily understand. But there are many transcribers available that can be utilized with minimal or no customization (apart from ordinary interfacing and setup). Examples include:

JasperTranscriber: A pretrained network from the NeMo library based on the paper “Jasper: An End-to-End Convolutional Neural Acoustic Model”.
QuartzNetTranscriber: A smaller pretrained network based on a refinement of the Japser Architecture. It is available in the NeMo library and based on the paper “QuartzNet: Deep Automatic Speech Recognition with 1D Time-Channel Separable Convolutions”.
Wav2LetterTranscriber: An architecture developed by the Facebook team, shown in the paper “Wav2Letter: an End-to-End ConvNet-based Speech Recognition System”.
RNNTranscriber: An RNN-based transformer available in the ESPNet framework. See “ESPnet: End-to-End Speech Processing Toolkit”.
TransformerTranscriber: A transformer-based ASR engine, also in the ESPNet framework shown in “ESPnet: End-to-End Speech Processing Toolkit”.

The NeMo packages, the ESPNet framework, and Wav2LetterTranscriber have been found to be particularly suitable, depending on preferred design goals. The NeMo packages from Nvidia offers a suite of transcribers that work on a character level. ESPNet defines a series of subword-based transcribers and Wav2Letter defines a word-based transcriber.

Common elements and behaviors of different neural network models can be encapsulated by a class object. A preferred embodiment can include hardware, a software framework, and an application programming interface (API) that encapsulates implementation details of different engines. The framework and architecture can be applied to the domain of natural language processing. The embodiment can present a simplified, high-level user interface (UI) to the user. The implementation of each solution has a range of options, and the framework can alleviate the requirement for a user implementing a particular solution to know the syntaxes required to implement those options. An abstract class, Transcriber, can be defined to encapsulate the transcription process. In a preferred embodiment Transcriber possesses just one function. A number of transcribers can be available upon loading a transcribers sub-module. To access them on their own, then, they only need to be imported. For example:

Transcribe (path)->(str, np.array): The path variable is the location of the audio file to be transcribed and the variables that are returned are the transcription text and the character level log-probabilities. In the cases in which the transcriber did not define decodings, the return is a one-hot encoding of the characters of the text.

from speech . transcribers import JasperTranscriber
text , enc = JasperTranscriber . transcribe ( example_file )
print(text )

Transcribers can work in different ways. The Jasper and QuartzNet utilize the NeMo factory, which is instantiated and run natively in Python. The Wav2Letter Transcriber is run by piping text to a subprocess. The ESPNet output is taken from a shell command. Depending on the type of output, each type of output requires a different type of post-processing. Typically, no post-processing can be used, or a language model can be applied using a beam search to the output.

Automated speech recognition models can benefit from the use of language models. For example, optimizing transcription can be achieved by using language models. One idea behind a language model is that there is a way of estimating the likelihood of a text occurring according to a distribution. As most probabilities are expected to be extremely small, as a matter of convention, the output of these models can be given by a log-likelihood of a text. Furthermore, some models can be trained for context-specific information. Others can be static and/or pretrained.

Although not typically considered a language model, edit distance calculators and phonetic distance calculators can fit within the category of language models here. For example, from a spell-correction standpoint, the greater the edit or phonetic distance is from a text, the less likely the text is the corrected version of that text.

Embodiments can take advantage of abstracted language models. Several can readily be developed and implemented. For example:

score (text, target text)->float: This function returns the log-likelihood of a text appearing and is the main function required for the beam search.
fit (texts): This function fits the language model (e.g., Kneser-Neys, Laplacian smoothed n-gram counts) to an iterable of texts.
save/Load (path): Because training can take considerable time, it can be advantageous to be able to quickly save and load the models from a given path.

Various language models can be utilized. Examples of available models include:

KenLMScorer and KenLMScorerWSJ: Two large pretrained model built with the KenLM library from a large corpus of student responses for the first model and the Wall Street Journal for the second. Both are modified Kneser-Neys models built from pruned 6-grams.
KneserNeyScorer: A model that requires fitting to a training corpus built from 4-grams.
Edit Distance Scorer: A simple model that returns a Laplacian smoothed log edit distance between a target text and a given text.
Phonetic Distance Scorer: The same as the edit distance scorer with phonetic representations.
MixedScorer: A scorer based on a collection of scorers and coefficients. Given each scorer is a function, f₁, . . . , fₙ, and the coefficients are a₁, . . . , aₙ, the MixedScorer function is

$$F = {\sum }_{i = 1}^{n} {a}_{i} {f}_{i}$$

The fit, load, and save functions apply to each of the scorers. This can be simplified. for example, a function StandardLanguageModel can be implemented to create a model with known good properties:

LM = StandardLanguageModel ( )
LM.fit ( W2LBERT . train_text )

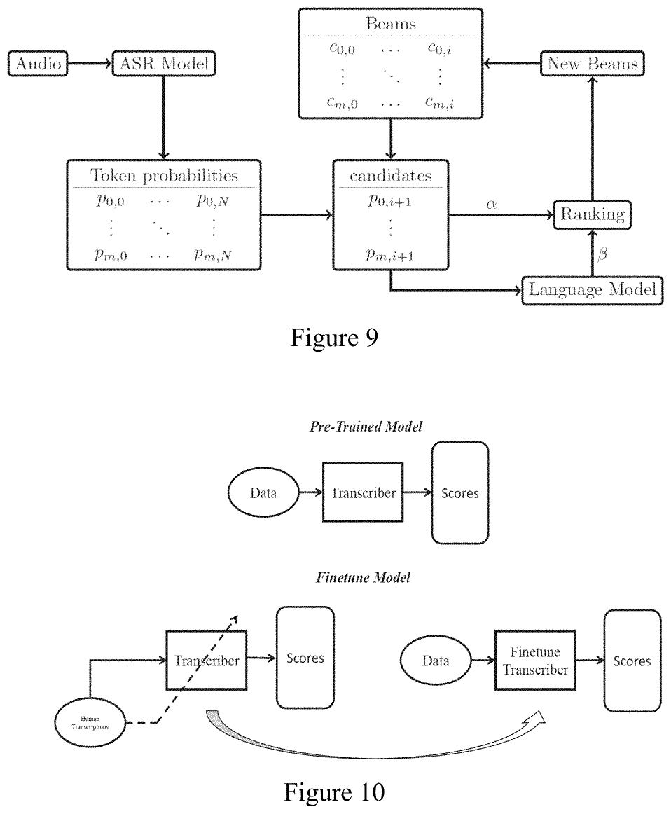

FIG. 9 illustrates a beam search. The beam search can work iteratively on the tokens. A goal of a beam search can be picking the best and/or most likely transcribed word. It can use the probability of a next word and check a graph to see which word has the highest probability.

Beam search can be implemented in various ways. In some embodiments, two beam search modes are available (in addition to the default None). These can work on a word level and/or a character level.

beam_search_words (text ,LM ,10)
text_series .map( lambda x: beam_search_words (x,LM ,10))

FIG. 10 shows a finetuning process. The pretrained models can be trained on, for example, classical audio books and/or other sources, such as those listed herein. As an example, a set of 100 human transcriptions can be utilized for finetuning a model of the data set to improve transcriptions. A set of data can be set aside and reserved for human transcription. A human transcription set can be used to finetune the model. Whatever method is implemented, the finetuned model can be used to transcribe the audio files.

Table 1 shows results of finetuning for 100 human transcriptions tested with different models.

TABLE 1

| | Google | Wav2Letter | ESPNet | ESPNet-Finetune |
|---|---|---|---|---|
| WER | 0.472689 | 0.52521 | 0.548319 | 0.429142 |
| CER | 0.352701 | 0.382263 | 0.33894 | 0.278879 |

The results show a gain in performance and error rates based on finetuning the models. Both the word error rate and the character error rate are lower than Google's APIs. In turn, the better transcribers can boost the overall performance of the engine.

Various neural networks can be implemented. Deep neural networks are utilized in preferred embodiments. For example, BERT can be utilized as a language model for classification of the text transcriptions. The engine can be flexible to allow addition and removal of multiple models. Examples of such models can include: BERT, ROBERTA, XLNET, ELECTRA, and REFORMER. The system can also benefit by having multiple language models in the ensembling task.

The ensembler can train a logistic regression classifier to the output of each neural network model to a set of scores on a test set. The scoring system of texts can operate on strings, which can be provided by the output of the language models. Speech data can be associated with a score or scores. Data frames can be utilized to read scores, such as from excel files, which can include paths to the speech data and the scores associated with it.

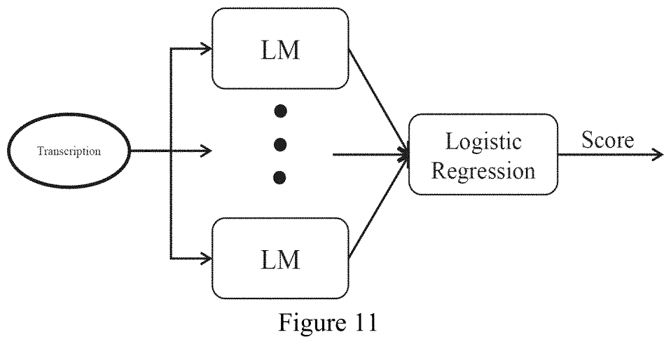

FIG. 11 shows ensembling using a logistic regression to optimize the result of each language model to classify audio files. The output of each neural network-based language model can be the probabilities in which the outputs of each model can be combined together and/or form the input of the logistic regression. A target label can be used to optimize the ensembler to pick the best model results and/or score the audio files. the outputs of each model

In order to examine the performance of the engine, the engine can be trained using, for example, three transcribers (Google, Wav2Let, and ESPNet) with the outputs of each transcriber entered into a BERT neural network with a classification head. For these data, no preprocessing need be conducted. Downsampling, however, can be useful, even if no preprocessing is conducted. The Wav2Let and ESPNet can be pre-trained using Librispeech corpus 2, is based mostly on audiobooks from the LibriVox project.

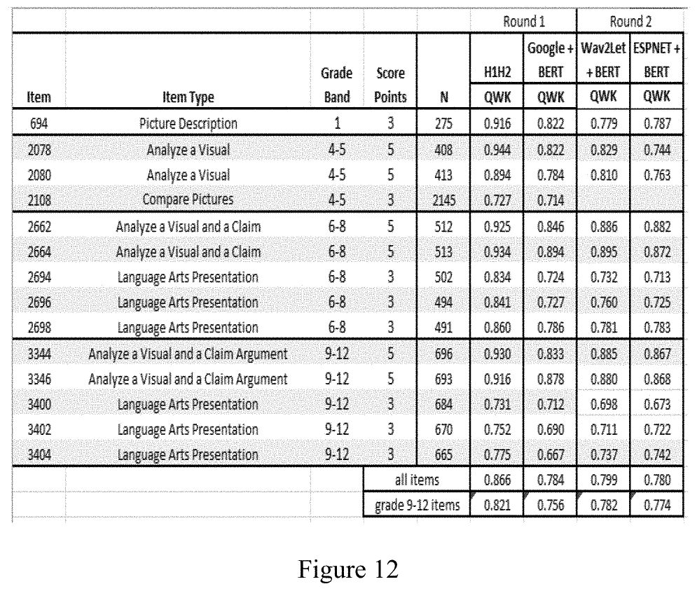

FIG. 12 shows various results from a specific example. Speech data and scores were taken from Washington and Oregon English Language Proficiency Assessments (ELPA) 21 screener data collected in the 2017-18 and 2018-19 academic years. Ninety percent of the sample was used for model training (with no ensembling). The remaining 10 percent was used for validation. Agreement results are presented in the figure. Each model underperformed relative to human agreement using quadratic weighted kappa (QWK) as the agreement metric. Nevertheless, the models were within accepted guidelines (within 0.01 of H1H2 QWK) for ten of the fourteen items. Performance was consistently good for grade 9-12 band items. The aggregate statistics across all items and grade 9-12 items are at the bottom of the figure.

Implementations can include general-purpose computers, processors, microprocessors, hardware and/or software accelerators, servers, and/or cloud-based technology (generically referred to herein as computers where context allows). The computer can have internal and/or external memory for storing data and programs such as an operating system (e.g., Linux, iOS, Windows 2000, Windows XP, Windows NT, OS/2, UNIX, etc.) and one or more application programs. Examples of application programs include computer programs implementing the techniques described herein, authoring applications (e.g., word processing programs, database programs, spreadsheet programs, simulation programs, and graphics programs) capable of generating documents or other electronic content, client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer, Google Chrome, Firefox, and Safari) capable of rendering standard Internet content and other content formatted according to standard protocols such as the Hypertext Transfer Protocol (HTTP), HTTP Secure, or Secure Hypertext Transfer Protocol.

The computers can include one or more central processing units (CPUs) for executing instructions in response to commands from executable code sent via communication devices for sending and receiving data. One example of the communication device can be an internal bus. Other examples include a modem, an antenna, a transceiver, a router, a dish, a communication card, a satellite dish, a microwave system, a network adapter, and/or other mechanisms capable of transmitting and/or receiving data, whether wired or wireless. In some embodiments, the processors can be graphics processing units (GPUs) or graphics accelerators. In preferred embodiments, tensor processing units (TPUs) are implemented. TPUs are relatively recent advancements originally designed for artificial intelligence accelerator application-specific integrated circuits (ASICs) developed by Google for neural network machine learning. The computers can also include input/output interfaces that enable wired and/or wireless connection to various peripheral devices. The peripheral devices can include a graphical user interface (GUI) and/or remote devices. A processor-based system of the computer can include a main memory, preferably random-access memory (RAM), or alternatively read-only memory (ROM), and can also include secondary memory, which can be any tangible computer-readable media. Tangible computer-readable medium memory can include, for example, hard disk drives, removable storage drives, flash-based storage systems, solid-state drives, floppy disk drives, magnetic tape drives, optical disk drives (e.g. Blu-Ray, DVD, CD drive), magnetic tapes, standalone RAM disks, etc. The removable storage drive can read from or write to a removable storage medium. As will be appreciated, the removable storage medium can include computer software and data.

As persons in the field will readily appreciate, embodiments can take on various hardware implementations. Below examples of specific hardware and software configurations are not intended as requirements for any one embodiment, but rather are provided to further elucidate the inventor's existing implementations. The machine learning framework can be based Pytorch and C++. This framework benefits greatly from the accelerated methods offered by Nvidia's CUDA language, which is exclusively available on Nvidia graphics cards. While CUDA accelerated methods have been available on Nvidia cards for some time, many cards also require more dedicated GPU memory than typically available on non-gaming PCs. Many consumer grade entry level graphics cards (e.g., GeForce GTX 1050 Ti, GeForce RTX 1060, Quadro P2000) are equipped with 2 Gb to 6 Gb. Preferred embodiments, however, utilize cards with at least 8 Gb of video memory. Optimally, cards will have 16 Gb or above. Cards with 16 Gb or above include the Quadro P/RTX 5000-8000 or V100, P40, Nvidia Titan RTX and GV100. In a preferred embodiment where such capacity is not available, AWS instances of the following types can be utilized:

p2.x-Series: The p2.x-series ec2 instances carry Tesla K80 graphics cards with 12 Gb of video memory. This will be sufficient for most tasks.
p3.x-Series: The p3.x-series ec2 instances carry Tesla V100 graphics cards with 16 Gb of video memory. Bigger tasks are optimally utilized on P3.
These two types of instances offer a level above the bare minimum. Also note that when using these models that benefit from pretraining, ample hard-disk space is also preferred to store the models.

By way of specific example, and in no way limiting the inventions herein according to the following, a procedure for installing various software components on hardware is provided below.

```
#wavletter
sudo apt-get install libblas-dev liblapack-dev
mkdir wav2lett
cd wav2lett
mkdir model
cd model
# ---download model----------
for f in acoustic model.bin tds_streaming.arch decoder_options.json
  feature_extractor.bin language_model.bin lexicon.txt
# ---download audio----------
cd . .
mkdir audio
cd audio
wget -qO- openslr.org/resources/12/dev-clean.tar.gz|tarxvz
find LibriSpeech/dev-clean -type f -name “*.flac” -exec sox { } { }
  “.wav” \;
find “$ (pwd) ”/ LibriSpeech/dev-clean -type f -name “*.wav” >
  LibriSpeech -dev-clean-wav-all.lst
wc -l LibriSpeech-dev-clean-wav-all.lst
cd ^{~}
gitclone github.com/kpu/kenlm.git
export EIGEN3 ROOT=$HOME/ eigen-eigen-07105f7124f9
cd $HOME; wget -O - bitbucket.org/eigen/eigen/get/3.2.8.tar.bz2 |tar
  xj
sudo apt-get install libbz2-dev
sudo apt-get install liblzma-dev
cd kenlm
mkdir build
cd build
sudo cmake . .
sudo apt-get install libboost-all-dev
sudo make -j $ ( nproc )
export MKLROOT=/opt /intel/mkl
37 cd ^{~}
git clone github.com/facebookresearch/wav2letter.git
cd wav2letter
mkdir build
cd build
sudo apt-get install libgflags-dev
sudo apt-get install libglfw3 -dev libfontconfig1-dev
sudo apt-get install libff tw3 -3
sudo apt-get i n s t a l l l i b f f tw3 -dev
KENLM ROOT DIR=^{~}/kenlm/build cmake . . -DW2L BUILD LIBRARIES ONLY=ON
  -DW2L BUILD INFERENCE=ON -DW2L LIBRARIES USE CUDA=OFF
# change the directory to inference
sudo make simple_streaming_asr_examp e -j $ ( nproc )
sudo make multithreaded_streaming_asr_example -j $ ( nproc )
sudo make interactive_streaming_asr_example -j $ ( nproc )
# ESPNet Installation
sudo apt-get install bc tree sox
sudo apt-get install build-essential cmake
sudo pip3 install torch --upgrade
cat / etc/os-release
## set environment
export CUDA HOME=/usr/local/cuda
export CUDA TOOLKIT ROOT DIR=$CUDA HOME
export LD LIBRARY PATH = “$CUDA HOME/extras/CUPTI/lib64 : $LD LIBRARY
  PATH”
export LIBRARY PATH = $CUDA HOME/lib64 : $LIBRARY PATH
export LD LIBRARY PATH=$CUDA HOME/lib64 : $LD LIBRARY PATH
export CFLAGS = “-I$CUDA HOME/include $CFLAGS”
## ESPNet setup
git clone github.com/espnet/espnet
cd espnet
sudo pip3 install -e .
sudo -H pip3 install --ignore-installed PyYAML
## kaldi setup
cd ^{~}/espnet/tools
git clone github.com/kaldi-asr/kaldi
cd ^{~}/espnet/tools/kaldi/tools/exras/
./ check_dependencies.sh
sudo apt-get install automake autoconf gfortran subversion
sudo ./ install_mkl.sh -sp debian intel -mkl-64bit -2020.0-088
cd ^{~}/espnet/tools/kaldi/tools
sudo make sph2pipe sclite
rm -rf espnet/tools/kaldi/tools/python
wget
  github.com/espnet/kaldi-bin/releases/download/v0.0.1/ubuntu16-featbi
  n.tar.gz
tar -xf ./ubuntu16-featbin.tar.gz
cp featbin /* ^{~}/espnet/tools/kaldi/src/featbin/
cd ^{~}/espnet/tools
sudo make CFLAGS = “-I$CUDAROOT/include $CFLAGS”
```

Additional files can facilitate extra functionality to the above embodiment. For example, the following additional folders can be included in the Datafiles.

/datafiles/pretrainedmodels/Japser-10x5dr/
/datafiles/pretrainedmodels/QuartzNet-15x5/
/datafiles/pretrainedmodels/wav2letter
/datafiles/pretrainedmodels/espnet
/datafiles/pretrainedmodels/kenlm

Similarly, additional packages can extend and improve the functionality of various embodiments. Examples of such useful packages can include: sox, espnet, wav2letter, nemotoolkit, kenlm, blas/atlas, pytorch, tensorflow, pandas, numpy, and Kaladi.

All of the systems and methods disclosed and claimed herein can be made and executed without undue experimentation in light of the present disclosure. While the apparatus and methods of this invention have been described in terms of preferred embodiments, it will be apparent to skilled artisans that variations may be applied to the methods and in the steps or in the sequence of steps of the method described herein without departing from the concept, spirit and scope, or the invention. In addition, from the foregoing it will be seen that this invention is one well adapted to attain all the ends and objects set forth above, together with other advantages. It will be understood that certain features and sub-combinations are of utility and may be employed without reference to other features and sub-combinations. This is contemplated and within the scope of the appended claims. All such similar substitutes and modifications apparent to skilled artisans are deemed to be within the spirit and scope of the invention as defined by the appended claims.

1. A system for machine learning assisted speech scoring, comprising:
a neural network having a nodes;
a memory storing executable software code, wherein the executable software code includes a software framework, a preprocessing submodule, a transcriber class, a confidence submodule, and an application programming interface;
a processor for implementing commands of the executable software code, wherein the commands include directing the processor to instantiate transcribers from the transcriber class, to invoke the preprocessing submodule, and to ensemble the transcribers, wherein the preprocessing submodule is configured to downsample a raw audio file into an audio file; and
wherein each node of the neural network includes one or more of the transcribers, wherein the transcribers are configured to create text from the audio file.

2. The system of claim 1, wherein the transcriber class is encapsulated by the application programming interface.

3. The system of claim 1, wherein the neural network is configured to score the text.

4. The system of claim 3, wherein the confidence submodule is configured to calculate probabilities that the text was transcribed accurately.

5. The system of claim 4, wherein the system is further configured to transcribe speech and predicts the score in parallel and to combine a plurality of scores to predict a final score.

6. A method of scoring speech, comprising:
preprocessing an audio file to filter out unscoreable audio and to downsample scorable audio;
transcribing the audio file among a plurality of automated transcribers into a plurality of transcripts; and
scoring the plurality of transcripts among nodes of a neural network to create a plurality of scores, wherein the transcribing and the scoring is performed in parallel.

7. The method of claim 6, further comprising ensembling the plurality of transcripts and the plurality of scores to predict a final score.

8. The method of claim 6, wherein the unscorable audio is an audio file that contains no speech, that is longer than a predetermined time, that is corrupted, or that contains speech from multiple speakers.

9. The method of claim 6, wherein preprocessing further comprises creating a condition code model.
